(19) United States
(12) Patent Application Publication
(10) Pub. No.: US 2026/0039035 A1
(43) Pub. Date: Feb. 5, 2026

(54) CONDUCTIVE MEMBER

(71) Applicant: YAZAKI CORPORATION, Tokyo (JP)

(72) Inventor: Shinichi YANAGIHARA, Shizuoka (JP)

(73) Assignee: YAZAKI CORPORATION, Tokyo (JP)

(21) Appl. No.: 19/283,859

(22) Filed: Jul. 29, 2025

(30) Foreign Application Priority Data
Aug. 5, 2024 (JP) 2024-128884

(51) Int. Cl. H01R 4/70; H01M 50/503; H01M 50/507; H01R 4/34

(52) U.S. Cl. CPC H01R 4/70; H01M 50/503; H01M 50/507; H01R 4/34

(57) ABSTRACT

A conductive member includes a strip-shaped flat conductor, a case having an accommodation groove that accommodates an intermediate portion of the flat conductor, a cover attached to the case in a manner of covering an upper opening of the accommodation groove and holding the flat conductor, and a flexible pressing piece integrally formed on an upper wall portion of the cover to press and bias an upper face of the flat conductor accommodated in the accommodation groove toward a bottom surface of the accommodation groove.

### CROSS-REFERENCE TO RELATED APPLICATIONS

This application is based on and claims priority under 35 USC 119 from Japanese Patent Application No. 2024-128884 filed on Aug. 5, 2024, the entire content of which is incorporated herein by reference.

### TECHNICAL FIELD

The present disclosure relates to a conductive member.

### BACKGROUND ART

In the related art, a conductive member that is connected to a power supply such as a battery and supplies electricity to an electrical component or the like has been used in a power supply circuit or the like. Such a type of conductive member may include a strip-shaped flat conductor (busbar) having a prescribed width.

The conductive member needs to ensure electrical insulation of the flat conductor. For example, there is known a technique of covering a flat conductor with an insulation material and a technique of insulating a flat conductor with a protector made of an insulation resin as disclosed in JP2014-107201A, JP2012-109152A, and JP2022-139669A.

For example, as illustrated in FIG. 6, a conductive member 501 in the related art includes a pair of strip-shaped flat conductors (busbars) 530, and a case 510 and a cover 520 that respectively face front and back surfaces of the flat conductors 530 and cover the flat conductors 530 from a plate thickness direction. The case 510 and the cover 520 integrally molded by injection molding or the like constitute a protector 505 made of an insulation resin.

As illustrated in FIG. 7, each of the flat conductors 530 is formed of a conductive metal plate having a substantially elongated flat plate shape and pressed into a prescribed shape, and is formed with a bolt through hole 533 in each of two end portions exposed from the case 510 and the cover 520.

The case 510 has a pair of accommodation grooves 511 that accommodate intermediate portions of the flat conductors 530, and case-side locking portions 515 provided on two side edge portions of the case 510. Each of the case-side locking portions 515 is provided with a locking hole 517.

The cover 520 covers upper opening sides of the accommodation grooves 511 with the flat conductors 530 interposed in between, and covers the flat conductors 530. The cover 520 has an upper wall portion 521 having substantially the same shape in a plan view as an outer shape of the pair of accommodation grooves 511, and cover-side locking portions 523 provided on two edge portions of the upper wall portion 521. Each of the cover-side locking portions 523 is provided with, on an outer surface side thereof, an engagement claw 524 fitted into and locked to the locking hole 517 of each of the case-side locking portions 515.

When the cover 520 is installed to the case 510, the engagement claws 524 of the cover-side locking portions 523 enter the locking holes 517 of the case-side locking portions 515. Accordingly, the engagement claws 524 of the cover-side locking portions 523 are locked to the locking holes 517 of the case-side locking portions 515, and the case-side locking portions 515 and the cover-side locking portions 523 are engaged and locked with each other.

Therefore, the protector 505 including the case 510 and the cover 520, which are engaged and locked, covers the intermediate portions of the flat conductors 530 from the plate thickness direction, thereby implementing the conductive member 501 in which a periphery of the flat conductors 530 is electrically insulated except two end portions where the bolt through holes 533 are formed.

However, as described above, the protector 505 that sandwiches the intermediate portions of the flat conductors 530 from the plate thickness direction and engages and locks the case 510 and the cover 520 does not have a structure that prevents positional deviation of the flat conductors 530 in a longitudinal direction. Therefore, when the linear flat conductors 530 are held by the conductive member 501 in the related art, the protector 505 may be displaced in the longitudinal direction of the flat conductors 530.

The present disclosure is made in view of the above circumstance, and an object of the present disclosure is to provide a conductive member that can prevent positional deviation of a protector relative to a flat conductor.

### SUMMARY OF INVENTION

A conductive member includes a strip-shaped flat conductor, a case having an accommodation groove that accommodates an intermediate portion of the flat conductor, a cover attached to the case in a manner of covering an upper opening of the accommodation groove and holding the flat conductor, and a flexible pressing piece integrally formed on an upper wall portion of the cover to press and bias an upper face of the flat conductor accommodated in the accommodation groove toward a bottom surface of the accommodation groove.

According to the conductive member of the present disclosure, positional deviation of a protector relative to the flat conductor can be prevented.

The present disclosure has been briefly described above. Details of the present disclosure can be clarified by reading a mode (hereinafter, referred to as “embodiment”) for carrying out the disclosure to be described below with reference to the attached drawings.

### BRIEF DESCRIPTION OF DRAWINGS

FIG. 1 is a perspective view of a conductive member according to an embodiment of the present disclosure;

FIG. 2 is an exploded perspective view of the conductive member illustrated in FIG. 1;

FIG. 3 is a perspective view of a cover illustrated in FIG. 2 as viewed from below;

FIG. 4 is a plan view of the conductive member illustrated in FIG. 1;

FIG. 5 is a cross-sectional view taken along a line V-V in FIG. 4;

FIG. 6 is a perspective view of a conductive member in the related art; and

FIG. 7 is an exploded perspective view of the conductive member illustrated in FIG. 6.

### DESCRIPTION OF EMBODIMENTS

Hereinafter, an embodiment of the present disclosure will be described with reference to the drawings.

A conductive member 1 according to the present embodiment is, for example, an inter-stack routing module used for electrical connection between a plurality of battery stacks 51. It is needless to say that the conductive member 1 of the present disclosure can be applied not only to the inter-stack routing module according to the present embodiment but also to various power supply circuits such as a high-voltage cable that electrically connects a battery assembly and a control device such as an inverter.

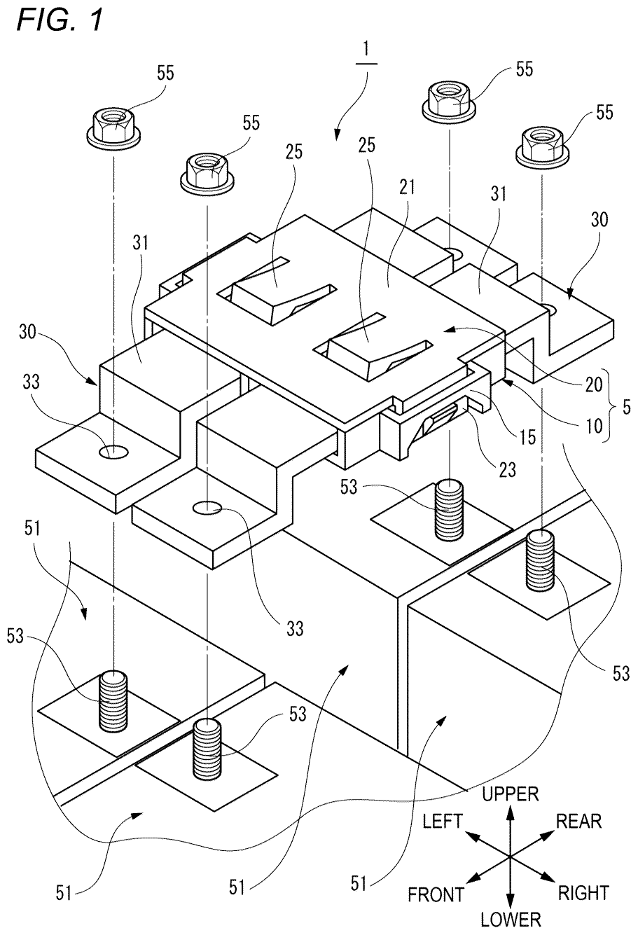

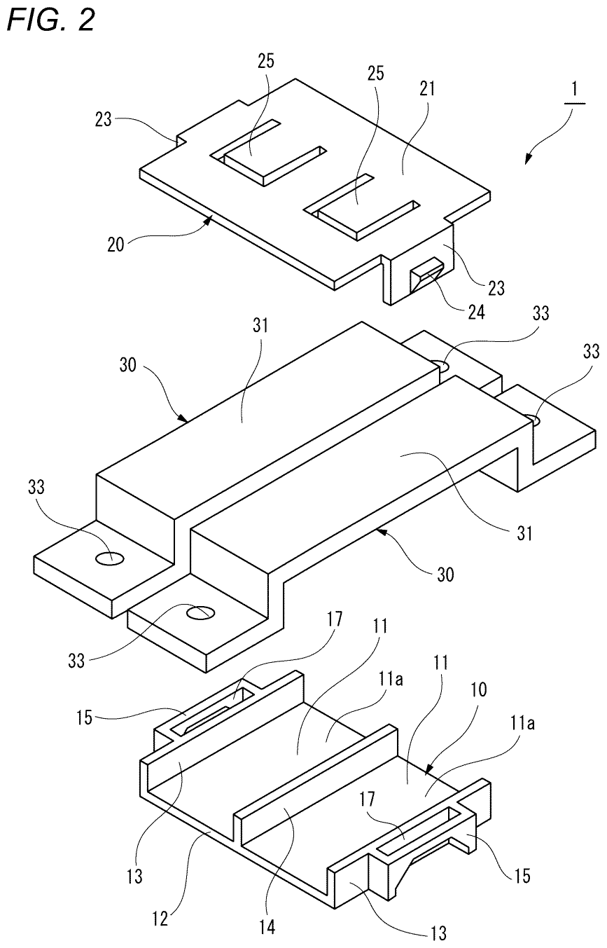

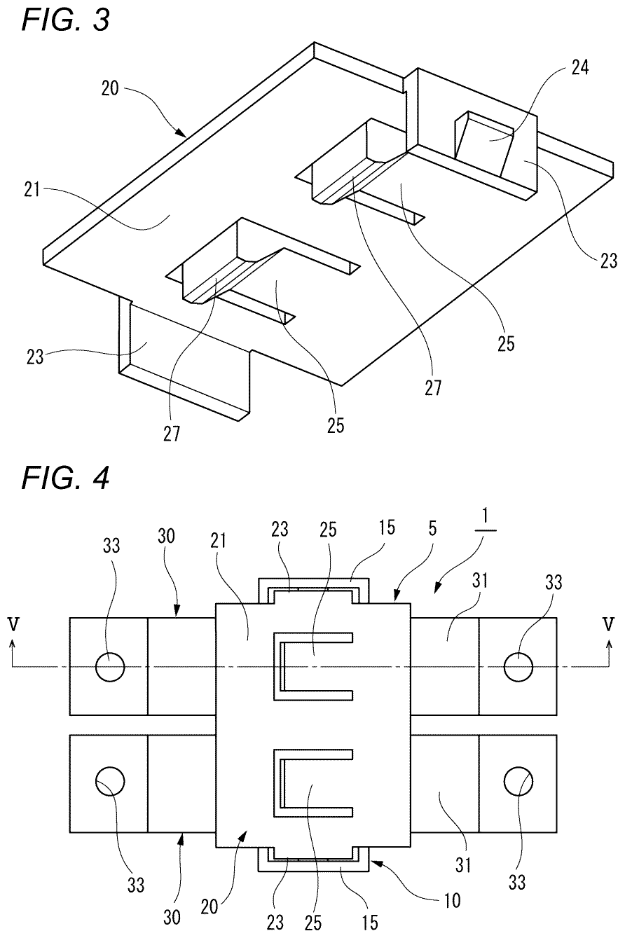

FIG. 1 is a perspective view of the conductive member 1 according to an embodiment of the present disclosure. FIG. 2 is an exploded perspective view of the conductive member 1 illustrated in FIG. 1. FIG. 3 is a perspective view of a cover 20 illustrated in FIG. 2 as viewed from below. In the present embodiment, upper-lower, front-rear, and left-right directions in the conductive member 1 follow upper-lower, front-rear, and left-right directions indicated by arrows in FIG. 1.

As illustrated in FIGS. 1 and 2, the conductive member 1 according to the present embodiment mainly includes a pair of strip-shaped flat conductors (busbars) 30, a case 10 having a pair of accommodation grooves 11 that accommodate intermediate portions of the flat conductors 30, a cover 20 attached to the case 10 in a manner of covering upper openings of the accommodation grooves 11 and holding the flat conductors 30, and flexible pressing pieces 25 integrally formed on an upper wall portion 21 of the cover 20. The case 10 and the cover 20 integrally molded by injection molding or the like constitute a protector 5 made of an insulation resin.

As illustrated in FIG. 2, each of the flat conductors 30 according to the present embodiment is formed of a conductive metal plate having a substantially elongated flat plate shape and pressed into a prescribed shape, and is formed with a bolt through hole 33 at each of two end portions exposed from the case 10 and the cover 20.

Various conductive metal materials such as copper, a copper alloy, aluminum, and an aluminum alloy can be used for the conductive metal plate.

The flat conductor 30 has an upper face 31 thereof processed to be rougher than other surfaces of the flat conductor 30 to increase a friction coefficient. Such processing for roughening a surface can adopt various methods such as surface roughening processing including etching, blasting, and shot peening, and pressing processing of an uneven surface at the same time as when a conductive metal material is punched into a prescribed shape.

As illustrated in FIG. 2, the case 10 according to the present embodiment includes a bottom wall portion 12 formed in a substantially rectangular shape in a plan view, and two side wall portions 13 vertically provided on two side edge portions of the bottom wall portion 12 in a left-right width direction.

In the case 10, the pair of accommodation grooves 11 are defined by a partition wall 14 vertically provided in a middle of the two side wall portions 13 of the bottom wall portion 12. The intermediate portions of the pair of flat conductors 30 arranged side by side are respectively accommodated in the pair of accommodation grooves 11.

Each of the two side wall portions 13 of the case 10 is provided with a case-side locking portion 15. The case-side locking portion 15 is provided with a locking hole 17 having a vertically running rectangular cross section.

As illustrated in FIGS. 2 and 3, the cover 20 according to the present embodiment includes an upper wall portion 21 formed in a substantially rectangular shape in a plan view, which is substantially the same as an outer shape of the pair of accommodation grooves 11, and cover-side locking portions 23 hanging down from two side edge portions of the upper wall portion 21 in the left-right width direction. Each of the cover-side locking portions 23 is provided with, on an outer surface side thereof, an engagement claw 24 that is fitted into and locked to the locking hole 17 of the case-side locking portion 15.

When the cover 20 is installed to the case 10, the engagement claws 24 of the cover-side locking portions 23 enter the locking holes 17 of the case-side locking portions 15. Accordingly, the engagement claws 24 of the cover-side locking portions 23 are locked to the locking holes 17 of the case-side locking portions 15, and the case-side locking portions 15 and the cover-side locking portions 23 are engaged and locked with each other.

Further, a pair of flexible pressing pieces 25 are integrally formed on the upper wall portion 21 of the cover 20. The flexible pressing pieces 25 are cantilevered flexible pieces integrally formed on the upper wall portion 21. Each of the flexible pressing pieces 25 is provided with, at a distal end portion thereof, a pressing protrusion 27 protruding downward from an inner surface of the upper wall portion 21.

Therefore, when the cover 20 is installed to the case 10, the flexible pressing pieces 25 can press and bias the upper faces 31 of the flat conductors 30 toward bottom surfaces 11a of the pair of accommodation grooves 11.

Next, an assembly procedure of the conductive member 1 will be described.

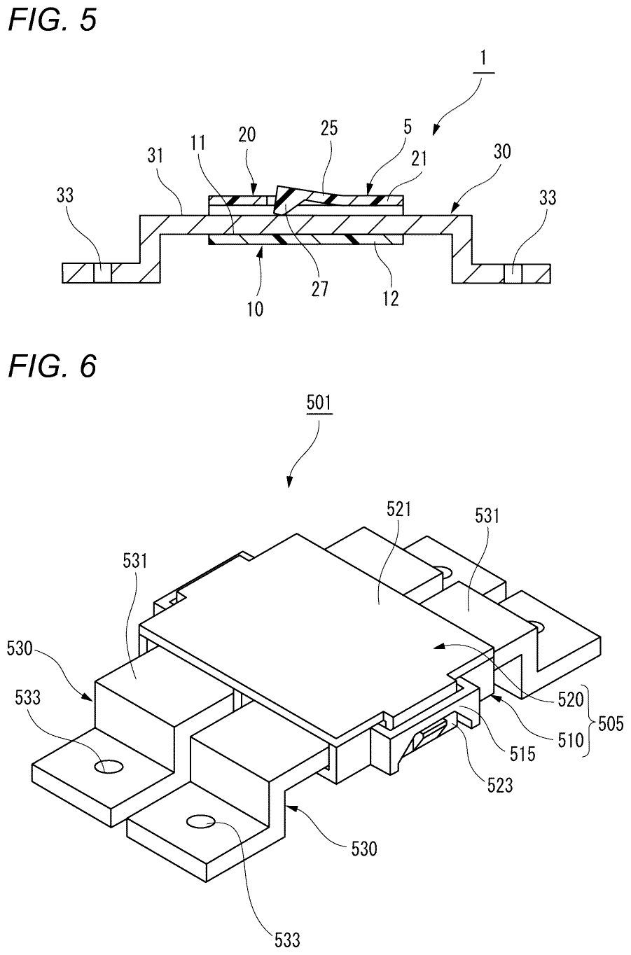

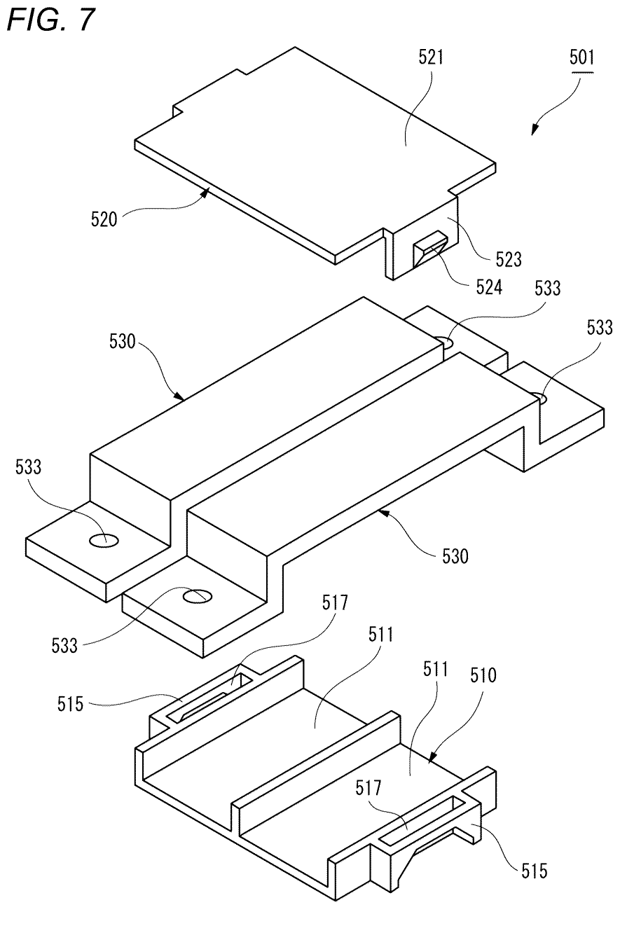

FIG. 4 is a plan view of the conductive member 1 illustrated in FIG. 1. FIG. 5 is a cross-sectional view taken along a line V-V in FIG. 4.

First, the intermediate portions of the flat conductors 30 are placed on and overlap the bottom surfaces 11a of the accommodation grooves 11 of the case 10. Two side edge portions of the flat conductors 30 placed on the bottom surfaces 11a of the accommodation grooves 11 are covered with the two side wall portions 13.

Next, as illustrated in FIG. 4, the upper wall portion 21 of the cover 20 is placed on the case 10 in a manner of covering the upper openings of the pair of accommodation grooves 11 and holding the flat conductors 30. At this time, the pair of cover-side locking portions 23 penetrate the locking holes 17 of the pair of case-side locking portions 15, respectively, and the engagement claws 24 of the cover-side locking portions 23 engage with opening edges of the locking holes 17.

That is, in the pair of cover-side locking portions 23 of the cover 20, the engagement claws 24 formed on the outer surface side are locked to the opening edges of the locking holes 17, respectively, so that detachment from the locking holes 17 is restricted. The protector 5 including the case 10 and the cover 20 that face front and back surfaces of the pair of flat conductors 30 and cover the flat conductors 30 from a plate thickness direction is integrally held by the pair of cover-side locking portions 23 and the pair of case-side locking portions 15.

As illustrated in FIG. 1, in the assembled conductive member 1, electrode bolts 53 of the battery stacks 51 are inserted into the bolt through holes 33 of the flat conductors 30, and nuts 55 are screwed and fastened to the electrode bolts 53, so that the plurality of battery stacks 51 can be electrically connected to each other.

Next, effects of the above-described configurations will be described.

According to the conductive member 1 in the present embodiment, the front and back surfaces of the flat conductors 30 excluding the two end portions where the bolt through holes 33 are formed are covered with the protector 5. Accordingly, the conductive member 1 can have good electrical insulation as a routing member.

In the protector 5 holding the flat conductors 30 as illustrated in FIG. 5, the pressing protrusions 27 come into contact with the upper faces 31 of the flat conductors 30 when the cover 20 is installed to the case 10, so that the flexible pressing pieces 25 bend upward. The pair of flexible pressing pieces 25 press and bias the upper faces 31 of the flat conductors 30 toward the bottom surfaces 11a of the pair of accommodation grooves 11.

Therefore, the conductive member 1 according to the present embodiment can prevent positional deviation of the protector 5 relative to the flat conductors 30 by a frictional force generated by the flexible pressing pieces 25 pressing the flat conductors 30 against the bottom surfaces 11a of the accommodation grooves 11.

In the conductive member 1 according to the present embodiment, the upper faces 31 of the flat conductors 30 with which the pressing protrusions 27 of the flexible pressing pieces 25 come into contact are processed to be rougher than other surfaces of the flat conductors 30 to increase a friction coefficient.

Therefore, a frictional force of the upper faces 31 of the flat conductors 30 that come into contact with the pressing protrusions 27 of the flexible pressing pieces 25 can be increased, and positional deviation of the protector 5 relative to the flat conductors 30 can be further prevented.

In the conductive member 1 according to the present embodiment, the case 10 has the pair of accommodation grooves 11 that respectively accommodate the intermediate portions of the pair of flat conductors 30 arranged side by side, and the pair of flexible pressing pieces 25 that respectively press and bias the upper faces 31 of the pair of flat conductors 30 toward the bottom surfaces 11a of the pair of accommodation grooves 11 are integrally formed on the upper wall portion 21 of the cover 20.

Therefore, the conductive member 1 can prevent the positional deviation of the protector 5 relative to the pair of flat conductors 30 by the frictional force generated by the pair of flexible pressing pieces 25 pressing the pair of flat conductors 30 against the bottom surfaces 11a of the pair of accommodation grooves 11.

Therefore, according to the conductive member 1 in the present embodiment, the positional deviation of the protector 5 relative to the flat conductors 30 can be prevented.

The present disclosure is not limited to the embodiment described above, and can be appropriately modified, improved, and the like. In addition, materials, shapes, sizes, numbers, arrangement positions, and the like of components in the embodiment described above are freely selected and are not limited as long as the present disclosure can be implemented.

Here, features of the conductive member of the present disclosure described above will be briefly summarized and listed in [1] to [3] below. [1] A conductive member (1) includes:
a strip-shaped flat conductor (30);
a case (10) having an accommodation groove (11) that accommodates an intermediate portion of the flat conductor (30);
a cover (20) attached to the case (10) in a manner of covering an upper opening of the accommodation groove (11) and holding the flat conductor (30); and
a flexible pressing piece (25) integrally formed on an upper wall portion (21) of the cover (20) to press and bias an upper face (31) of the flat conductor (30) accommodated in the accommodation groove (11) toward a bottom surface (11a) of the accommodation groove (11).

According to the conductive member (1) described in [1], it is possible to prevent positional deviation of a protector including the case (10) and the cover (20) relative to the flat conductor (30) by a frictional force generated by the flexible pressing piece (25) pressing the flat conductor (30) against the bottom surface (11a) of the accommodation groove (11).
[2] In the conductive member (1) according to [1], the upper face (31) of the flat conductor (30) with which a pressing protrusion (27) of the flexible pressing piece (25) comes into contact is processed to be rougher than other surfaces of the flat conductor (30) to increase a friction coefficient.

According to the conductive member (1) described in [2], a frictional force of the upper face (31) of the flat conductor (30) that comes into contact with the pressing protrusion (27) of the flexible pressing piece (25) can be increased, and positional deviation of the protector relative to the flat conductor (30) can be further prevented.
[3] In the conductive member (1) according to [1] or [2], the case (10) has a plurality of the accommodation grooves (11) that respectively accommodate intermediate portions of a plurality of the flat conductors (30) arranged side by side, and
a plurality of the flexible pressing pieces (25) that respectively press and bias upper faces (31) of the plurality of flat conductors (30) toward bottom surfaces (11a) of the plurality of accommodation grooves (11) are integrally formed on the upper wall portion (21) of the cover (20).

According to the conductive member (1) described in [3], it is possible to prevent positional deviation of the protector relative to the plurality of flat conductors (30) by a frictional force generated by the plurality of flexible pressing pieces (25) pressing the plurality of flat conductors (30) against the bottom surfaces (11a) of the plurality of accommodation grooves (11).

What is claimed is:

1. A conductive member comprising:
a strip-shaped flat conductor;
a case having an accommodation groove that accommodates an intermediate portion of the flat conductor;
a cover attached to the case in a manner of covering an upper opening of the accommodation groove and holding the flat conductor; and
a flexible pressing piece integrally formed on an upper wall portion of the cover to press and bias an upper face of the flat conductor accommodated in the accommodation groove toward a bottom surface of the accommodation groove.

2. The conductive member according to claim 1,
wherein the upper face of the flat conductor with which the pressing protrusion of the flexible pressing piece comes into contact is processed to be rougher than other surfaces of the flat conductor to increase a friction coefficient.

3. The conductive member according to claim 1,
wherein the case has a plurality of the accommodation grooves that respectively accommodate intermediate portions of a plurality of the flat conductors arranged side by side, and
wherein a plurality of the flexible pressing pieces that respectively press and bias upper faces of the plurality of flat conductors toward bottom surfaces of the plurality of accommodation grooves are integrally formed on the upper wall portion of the cover.

4. The conductive member according to claim 2,
wherein the case has a plurality of the accommodation grooves that respectively accommodate intermediate portions of a plurality of the flat conductors arranged side by side, and
wherein a plurality of the flexible pressing pieces that respectively press and bias upper faces of the plurality of flat conductors toward bottom surfaces of the plurality of accommodation grooves are integrally formed on the upper wall portion of the cover.
